(19) United States
(12) Patent Application Publication
(10) Pub. No.: US 2009/0026778 A1
(43) Pub. Date: Jan. 29, 2009

(54) Impact absorbing member and manufacturing method thereof

(75) Inventors: Masaru Murayama, Komaki-shi (JP); Junichiro Suzuki, Komaki-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 12/216,985

(22) Filed: Jul. 14, 2008

(30) Foreign Application Priority Data
Jul. 27, 2007 (JP) 2007-196404

(51) Int. Cl. B60R 19/34

(52) U.S. Cl. 293/133; 29/897.2; 29/527.6

(57) ABSTRACT

An object of the present invention is to provide an impact absorbing member capable of reducing a load at a load reducing object portion easily and a manufacturing method thereof. The impact absorbing member includes a long impact absorbing body in which the sectional shape in the direction of a short side thereof is substantially identical throughout the entire length in the length direction and at least one load reducing hole arranged in the load reducing object portion of the impact absorbing body. Because the load reducing hole is disposed, the load on the load reducing object portion can be reduced. Further, the load on the load reducing object portion can be reduced by a relatively simple work of arranging the load reducing hole.

### INCORPORATION BY REFERENCE

The disclosure of Japanese Patent Application No. 2007-196404 filed on Jul. 27, 2007 including the specification, drawings and abstract is incorporated herein by reference in its entirety.

### BACKGROUND OF THE INVENTION

1. Field of the Invention

The present invention relates to an impact absorbing member for protecting a passenger of a vehicle and a pedestrian by absorbing an impact upon collision and manufacturing method thereof.

2. Description of the Related Art

For example, Japanese Unexamined Patent Application Publication No. 2006-62635 and Japanese Unexamined Patent Application Publication No. 2007-118931 describe long impact absorbing members to be installed on a bumper beam or a roof side inner panel of a vehicle. The impact absorbing member absorbs energy upon collision by being deformed itself. Thus, if any impact absorbing member is disposed on a bumper beam, it can mitigate an impact applied to a pedestrian (hereinafter, referred to as “pedestrian”, which includes a rider of a bicycle or a motorcycle) upon collision. If the impact absorbing member is disposed on a roof side inner panel, the impact applied to a passenger of vehicle upon collision can be mitigated.

The long impact absorbing members described in Japanese Unexamined Patent Application Publication No. 2006-62635 and Japanese Unexamined Patent Application Publication No. 2007-118931 are produced by extrusion molding as described in paragraph 0035 of Japanese Unexamined Patent Application Publication No. 2006-62635 and paragraph [0039] of Japanese Unexamined Patent Application Publication No. 2007-118931. Thus, cross-sectional shape in the direction of a short side of the impact absorbing members described in Japanese Unexamined Patent Application Publication No. 2006-62635 and Japanese Unexamined Patent Application Publication No. 2007-118931 are identical throughout the entire length in the length direction. However, distribution of load of the impact absorbing member (speaking in detail, reaction force applied from the impact absorbing member to an impact applying object if the impact applying object collides with the impact absorbing member) is not uniform throughout the entire length in the length direction.

For example, the central portion in the length direction of the impact absorbing member is restrained by adjacent portions on both sides in the length direction of the central portion. Thus, the impact absorbing member is hard to deform. Therefore, the load on the central portion in the length direction is large. Contrary to this, as for both end portions in the length direction of the impact absorbing member, an adjacent portion in the length direction exists respectively on only one side. That is, for the left end portion of the impact absorbing member, the adjacent portion exists only on the right side and for the right end portion of the impact absorbing member, the adjacent portion exists only on the left side. Thus, the both end portions in the length direction of the impact absorbing member are easy to deform. Therefore, the load on the both end portions in the length direction of the impact absorbing member is small.

In the case of the long impact absorbing members described in Japanese Unexamined Patent Application Publication No. 2006-62635 and Japanese Unexamined Patent Application Publication No. 2007-118931, the load on the central portion in the length direction is large while the load on both end portions in the length direction are small. For the reason, if a pedestrian or a passenger collides with the central portion in the length direction of the impact absorbing member, he or she receives a large reaction force from the impact absorbing member. On the other hand, if the pedestrian or passenger collides with both end portions in the length direction of the impact absorbing member, he or she receives a small reaction force from the impact absorbing member. Thus, if the load on the central portion in the length direction is set a load value suitable for protecting the pedestrian or passenger, the load on the both end portions in the length direction is short. On the other hand, if the load on the both end portions in the length direction is set to a load value suitable for protecting the pedestrian or passenger, the load on the central portion in the length direction is excessively large.

It can be considered to suppress unevenness in distribution of load in the length direction by adjusting the thickness of the wall portion of the impact absorbing member partially. That is, it can be considered to suppress unevenness in distribution of the load in the length direction by setting the thickness of the wall portion on both end portions in the length direction of the impact absorbing member larger than the thickness of the wall portion on the central portion in the length direction.

However, the long impact absorbing member is often produced by extrusion molding. In this case, the sectional shape in the direction of a short side of the impact absorbing member is substantially identical throughout the entire length in the length direction of the impact absorbing member. That is, the thickness of the wall portion is substantially identical throughout the entire length in the length direction of the impact absorbing member. Thus, adjustment of the thickness of the wall portion is carried out after extrusion molding of the impact absorbing member. More specifically, to decrease the thickness of the wall portion on the central portion in the length direction of the impact absorbing member after extrusion molding, the wall portion on the central portion in the length direction needs to be ground. However, the grinding operation is complicated.

### SUMMARY OF THE INVENTION

The impact absorbing member and its manufacturing method of the present invention have been achieved in views of the above-described problems. Accordingly, an object of the present invention is to provide an impact absorbing member which is capable of reducing the load at a desired load reducing object location, for example, on the central portion in the length direction, and a manufacturing method thereof.

(1) To achieve the above-described object, the present invention provides an impact absorbing member comprising: a long impact absorbing body in which the sectional shape in the direction of a short side thereof is substantially identical throughout the entire length in the length direction; and at least one load reducing hole disposed at load reducing object portion of the impact absorbing body.

The load reducing object portion mentioned here refers to a portion in which the load applied thereto in the impact absorbing body needs to be reduced. For example, it is a portion which receives a larger load than other portions. As the load reducing object portion, if the impact absorbing member is disposed on a bumper, the vicinity of a head lamp installation portion of a bumper fascia can be mentioned. The reason is that the strength of the vicinity of the head lamp installation portion is set high preliminarily in order to install the head lamp.

As the load reducing object portion, if the impact absorbing member is disposed on a bumper and the bumper fascia is provided with a step, the vicinity of that step can be mentioned. The reason is that the strength of the vicinity of the step is intensified by “rib effect” of the wall portion which constitutes the step.

At least one load reducing hole is disposed at the load reducing object portion of the impact absorbing body of the impact absorbing member of the present invention. Thus, the load at the load reducing object portion can be reduced. Further, the load at the load reducing object portion can be reduced by a relatively simple work of arranging the load reducing hole.

It is preferable that, in the impact absorbing member of the present invention, ribs, etc. are not erected substantially perpendicularly to the direction of development of the face of openings of the load reducing hole from the edge of the load reducing hole. The reason is that the load of the load reducing object portion is increased easily if the ribs, etc. are disposed on the hole edge.

(2) It is preferable that, in the impact absorbing member having the above-described structure (1), the load reducing object portion is a central portion in the length direction of the impact absorbing body. As described previously, the load on the central portion in the length direction of the impact absorbing body is larger than on both end portions in the length direction of the impact absorbing body. Thus, distribution of the load on the impact absorbing body is not uniform throughout the entire length in the length direction.

In the impact absorbing member having this structure, by arranging the load reducing hole, the load on the central portion in the length direction of the impact absorbing body can be decreased. Thus, a difference between the load on the central portion in the length direction of the impact absorbing body and the load on both end portions in the length direction of the impact absorbing body can be decreased. Therefore, unevenness of distribution of the load in the length direction of the impact absorbing body can be suppressed.

(3) It is preferable that, the impact absorbing member having the above-described structure (1), the impact absorbing body includes an outer cylinder and a plurality of inner ribs whose faces are developed substantially perpendicular to the direction of a load input at the time of a collision while connecting the inner faces of the outer cylinder and deformed by tension at the time of a collision, wherein the load reducing hole is bored in the outer cylinder.

According to the impact absorbing body of the impact absorbing member having such a structure, when the inner ribs are deformed by tension, part of energy at the time of collision is consumed. Thus, the load at an initial period of a collision is not increased rapidly. Thus, a large load can be prevented from being applied to a collision object (for example, a passenger or pedestrian) at the initial period of a collision. Further, deformation of the inner rib by tension is executed continuously from the initial period of a collision to a termination period. Thus, a load raised at the initial period of the collision is not decreased easily. Therefore, energy at the time of collision can be absorbed effectively.

In the impact absorbing member having this structure, no load reducing hole is arranged in the inner rib. Thus, when the inner rib is deformed by tension, the inner rib can be blocked from being broken from the edge of the load reducing hole as a starting point.

(4) It is preferable that, in the impact absorbing member having the above-described structure (3), the outer cylinder includes an input wall portion to which a load is input, an output wall portion which outputs the load to an adjacent member while disposed substantially in parallel to the input wall portion; and a pair of connecting wall portions for connecting the input wall portion with the output wall portion, wherein a pair of the inner ribs are disposed substantially in parallel to the input wall portion and the output wall portion while the pair of the inner ribs connect the inner faces of the pair of the connecting wall portions, and the load reducing holes are bored in the input wall portion and the output wall portion.

The load reducing holes of the impact absorbing member having this structure are bored in the input wall portion and the output wall portion. The input wall portion and the output wall portion are surface-developed substantially perpendicular to a load input direction. Thus, the impact absorbing member having this structure can reduce the load at the load reducing object portion effectively. For example, even if the opening area of the load reducing holes is small, the load at the load reducing object portion can be reduced.

(5) It is preferable that, in the impact absorbing member having the above-described structure (1), the diameter of the load reducing hole is set to more than 0% to 90% or less when the entire length in the direction of a short side of the impact absorbing body is assumed to be 100%.

The reason why the diameter of the hole is set to 90% or less is that if it exceeds 90%, the load reducing hole with respect to the entire length in the direction of short side of the impact absorbing body is excessively large, thereby the load is reduced extremely. That is, the reason is that it is difficult to set up the load for the load reducing object portion.

More preferably, the diameter of the load reducing hole is set to 80% or less if the entire length in the direction of a short side of the impact absorbing body is assumed to be 100%. Consequently, the setting of the load at the load reducing object portion is simplified.

(6) It is preferable that, in the impact absorbing member having the above-described structure (1), a plurality of the load reducing holes are disposed and an interval between most proximate positions of a pair of the load reducing holes adjacent each other in the length direction of the impact absorbing body is set to more than 0 mm to 80 mm or less. The reason why the interval between the adjacent load reducing holes is set to 80 mm or less is that if it exceeds 80 mm, the interval becomes excessively large so that the load on the load reducing object portion is not reduced easily. More preferably, the interval between the pair of the adjacent load reducing holes in the length direction of the impact absorbing body is set to 50 mm or less. Consequently, the setting of the load on the load reducing object portion is simplified.

(7) Further, to solve the above-mentioned problem, according to another aspect, the present invention provides a manufacturing method of impact absorbing member comprising: extrusion molding step of forming an impact absorbing body having a sectional shape in the direction of a short side corresponding to a portion requiring a strength most by extrusion molding; and hole arranging step of arranging at least one load reducing hole at a load reducing object portion of the impact absorbing body.

The manufacturing method of the impact absorbing member of the present invention has the extrusion molding step and the hole arranging step. In the extrusion molding step, the impact absorbing body is produced by extrusion molding. Consequently, the sectional shape in the direction of a short side of the impact absorbing body becomes substantially identical throughout the entire length in the length direction. Here, the sectional shape in the direction of the short side is set corresponding to a portion requiring the strength most in the length direction of the impact absorbing body.

In the hole arranging step, at least one load reducing hole is arranged in the load reducing object portion. That is, the sectional shape in the direction of the short side of the impact absorbing body produced in the extrusion molding step is set corresponding to the portion requiring the strength most. Thus, for a portion which requires not so high strength as compared with that portion requiring the strength most, the load becomes excessively large. Thus, in this step, the load reducing hole is arranged in the load reducing object portion to reduce the load.

According to the manufacturing method of the impact absorbing member of the present invention, the load on the load reducing object portion can be reduced. Further, by setting the sectional shape in the direction of a short side of the impact absorbing body corresponding to a portion which requires the strength most and next, disposing the load reducing hole on the load reducing object portion, distribution of the load throughout the entire length in the length direction of the impact absorbing body can be set up freely.

Consequently, the present invention can provide an impact absorbing member which can reduce the load on a desired load reducing object portion, for example, on the central portion in the length direction, easily and a manufacturing method thereof.

### BRIEF DESCRIPTION OF THE DRAWINGS

FIG. 1 is a transparent perspective view of the vicinity of a front bumper of a vehicle in which the impact absorbing member of the first embodiment is disposed;

FIG. 2 is a sectional view taken along line II-II in FIG. 1;

FIG. 3 is a perspective view of the interior of a vehicle compartment in which the impact absorbing member of the second embodiment is disposed;

FIG. 4 is a sectional view taken along line IV-IV in FIG. 3;

FIG. 5 is a schematic diagram of striker impact experiment;

FIG. 6 is a perspective view of a sample of the practical example sample;

FIG. 7 is a top view of the sample of the practical example sample;

FIG. 8 is a sectional view taken along line VIII-VIII in FIG. 7;

FIG. 9A is a schematic diagram showing a condition of impact initial period when the central portion in the right and left direction of the practical example sample is hit against a striker;

FIG. 9B is a schematic diagram showing a condition of collision intermediate period when the central portion in the right and left direction of the practical example sample is hit against a striker;

FIG. 9C is a schematic diagram showing a condition of collision termination period when the central portion in the right and left direction of the practical example sample is hit against a striker;

FIG. 10 is a graph showing the relation between displacement and load at a predetermined collision position of the practical example sample;

FIG. 11 is a graph showing the relation between a collision position and maximum load of the samples of the practical example and comparative example; and

FIG. 12 is a graph showing the relation between a collision position and energy amount of the samples of the practical example and the comparative example.

### DETAILED DESCRIPTION OF THE PREFERRED EMBODIMENTS

Hereinafter, the impact absorbing member and manufacturing method of the present invention will be described with reference to the accompanying drawings.

### First Embodiment

### [Arrangement of Impact Absorbing Member]

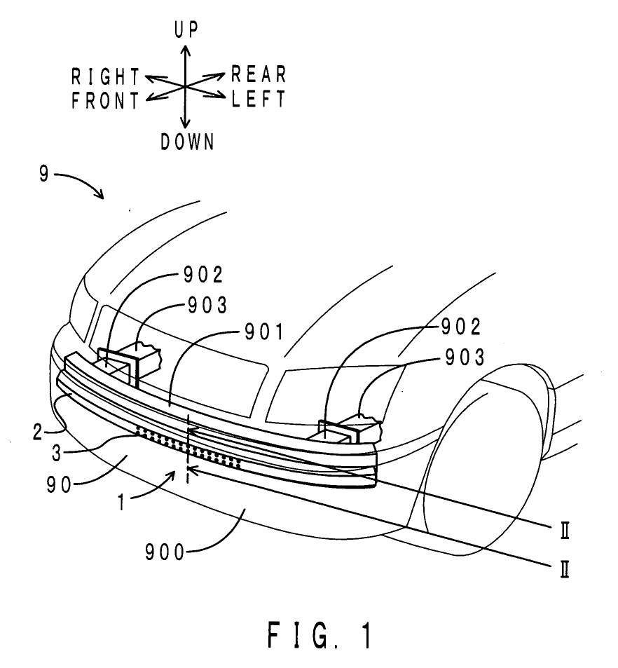

First, the arrangement of the impact absorbing member of this embodiment will be described. FIG. 1 shows a transparent perspective view of the vicinity of the front bumper of a vehicle in which the impact absorbing member of this embodiment is disposed. In the meantime, in FIG. 1-FIG. 4, the directions (right/left) are defined as a vehicle is viewed from its rear to the front.

As shown in FIG. 1, a front bumper 90 of a vehicle 9 includes a bumper fascia 900, a bumper beam 901 and a crush box 902. The impact absorbing member 1 is disposed in front of the bumper beam 901. In the meantime, the bumper beam 901 is included in the adjacent member of the present invention.

The bumper beam 901 is made of aluminum alloy. The bumper beam 901 is of a long quadrangular pipe shape. The bumper beam 901 is extended in the vehicle width direction (right and left direction).

The crush box 902 is made of aluminum alloy. The crush box 902 is of a box shape which is open rearward. Two crush boxes 902 are disposed apart from each other in the vehicle width direction. A pair of the crush boxes 902 are respectively fixed to the front ends of the front side members 903 such that their openings are closed. Right and left end portions of the bumper beam 901 are fixed to the front wall of the pair of the crush boxes 902.

The bumper fascia 900 is made of olefin resin. The bumper fascia 900 is of a long shape. The bumper fascia 900 is extended in the vehicle width direction. The bumper fascia 900 covers the bumper beam 901 and the impact absorbing member 1 from the front.

### [Structure of Impact Absorbing Member]

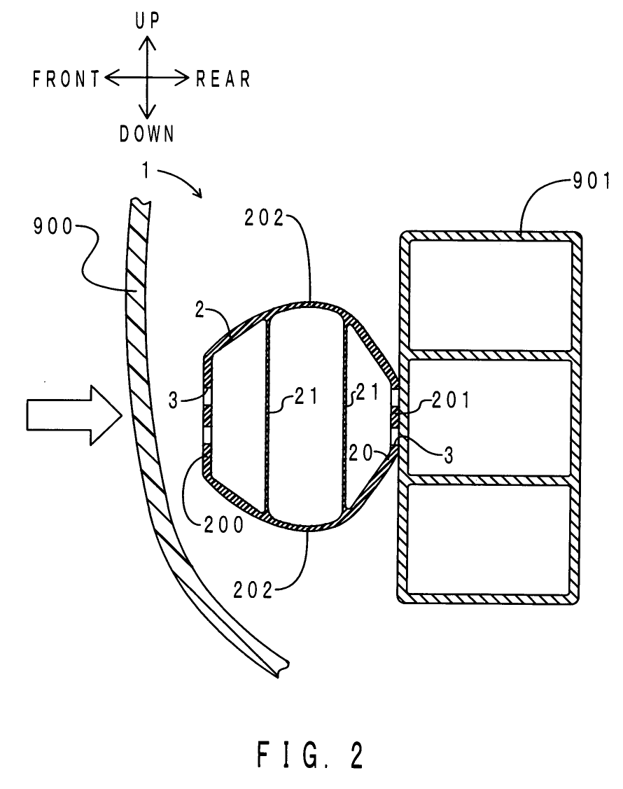

Next, the structure of the impact absorbing member 1 of this embodiment will be described. FIG. 2 shows a sectional view taken along line II-II in FIG. 1. As shown in FIG. 2 and FIG. 1, the impact absorbing member 1 of this embodiment includes an impact absorbing body 2 and an load reducing hole 3.

The impact absorbing body 2 is extended in the right and left direction along the front face of the bumper beam 901. The impact absorbing body 2 is fixed to the front face of the bumper beam 901 with adhesive agent. The impact absorbing body 2 includes an outer cylinder 20 and a pair of inner ribs 21.

The outer cylinder 20 is of a substantially octagonal pipe shape. The outer cylinder 20 is comprised of an input wall portion 200, an output wall portion 201 and a pair of connecting wall portions 202. The input wall portion 200 is of a flat plate shape and disposed on the front edge of the outer cylinder 20. The output wall portion 201 is of a flat plate shape and disposed on the rear edge of the outer cylinder 20. The output wall portion 201 is disposed substantially in parallel to the input wall portion 200. Of the pair of the connecting wall portions 202, the upper connecting wall portion 202 is of a arc plate shape which is expanded upward and connects the top edge of the input wall portion 200 with the top edge of the output wall portion 201. Of the pair of the connecting wall portions 202, the lower connecting wall portion 202 is of an arc plate shape which is expanded downward and connects the bottom edge of the input wall portion 200 with the bottom edge of the output wall portion 201.

A pair of the inner ribs 21 are of plate which is extended in the right and left direction. The pair of the inner ribs 21 are disposed inside the outer cylinder 20. The pair of the inner ribs 21 connect the inner faces of the pair of the connecting wall portions 202. The pair of the inner ribs 21 are disposed substantially in parallel to the input wall portion 200 and the output wall portion 201.

The load reducing holes 3 are a perfect circle and bored in the input wall portion 200 and the output wall portion 201 of the outer cylinder 20. The load reducing holes 3 are disposed in two rows, upper and low (15 holes/row×two rows) of the input wall portion 200. The 30 load reducing holes 3 are disposed on the central portion in the right and left direction of the input wall portion 200. Likewise, the load reducing holes 3 are disposed in two upper and lower rows (15 holes/row×two rows) of the output wall portion 201. These 30 load reducing holes 3 are disposed on the central portion also in the right and left direction of the output wall portion 201.

### [Manufacturing Method of Impact Absorbing Member]

Next, the manufacturing method of the impact absorbing member 1 of this embodiment will be described. The manufacturing method of the impact absorbing member 1 of this embodiment has extrusion molding step and hole arranging step. First, the extrusion molding step will be described. In the extrusion molding step, first, raw material resin (product name “UBE Nylon 6” (manufactured by UBE INDUSTRIES, LTD., product number “1013IU50”) is applied to an extrusion molding machine so as to produce a long extruded product. The sectional shape in the direction of a short side of the extrusion molding material is set for both end portions in the length direction which requires the strength most in the length direction of the impact absorbing body 2. Subsequently, the extrusion molding material is cut to each predetermined size. After that, the cut extrusion molding material is formed into the predetermined curved shape along the shape of the front face of the bumper beam 901. Consequently, the impact absorbing body 2 is produced.

Next, the hole arranging step will be described. In the hole arranging step, a plurality of the load reducing holes 3 are bored at predetermined positions including the central portion in the length direction of the input wall portion 200 and the output wall portion 201 of the impact absorbing body 2. As a result, the impact absorbing member 1 of this embodiment is produced.

### [Movement of Impact Absorbing Member]

Next, the movement of the impact absorbing member 1 of this embodiment when a pedestrian collides with a vehicle 9 will be described. When a pedestrian collides with the central portion in the right and left direction of the bumper fascia 900 of the vehicle 9, a load is input from the front to the rear as indicated with a blank arrow in FIG. 2. The input load is transmitted to the impact absorbing body 2 through the bumper fascia 900. The impact absorbing body 2 is deformed such that it is crushed in the back and forth direction between the bumper fascia 900 and the bumper beam 901. At this time, the outer cylinder 20 of the impact absorbing body 2 is deformed so that it is expanded vertically. Thus, the inner ribs 21 are supplied with tension from up and down. The inner ribs 21 are pulled and deformed by that tension.

A plurality of the load reducing holes 3 are bored in the input wall portion 200 and the output wall portion 201 of the impact absorbing body 2. Thus, as compared with a case where no load reducing holes 3 are bored in the input wall portion 200 and the output wall portion 201, the strength of the input wall portion 200 and the output wall portion 201 is low. Thus, the input wall portion 200 and the output wall portion 201 are deformed relatively easily. In this way, the impact absorbing member 1 of this embodiment absorbs an impact upon collision. In the meantime, a process of deformation at the time of collision of the impact absorbing member of the present invention will be described in detail with examples described later.

### [Operation and Effect]

Next, the operation and effect of the impact absorbing member 1 and the manufacturing method of this embodiment will be described. In the impact absorbing member 1 of this embodiment, when the inner ribs 21 are pulled and deformed, part of energy at the time of collision is consumed. Thus, the load at the initial period of the collision cannot be increased rapidly. Thus, application of a large load on any collision object (for example, a passenger or a pedestrian) at the initial period of the collision can be suppressed. Further, the tensile deformation of the inner ribs 21 occurs continuously from the initial period of the collision to the termination period. Thus, after the load which is raised at the initial period of the collision does not drop easily. Thus, energy at the time of collision can be absorbed effectively.

According to the impact absorbing member 1 of this embodiment, the impact absorbing body 2 is made of “UBE Nylon 6”. The “UBE Nylon 6” is preferable as the material of the impact absorbing body 2 because its flexural modulus is 1 GPa or higher, tensile fracture elongation is 100% or more, and tensile yield stress is 15 MPa or more. The impact absorbing body 2 is manufactured by extrusion molding. Extrusion molding is particularly preferable as a forming method for the impact absorbing body 2 because it is effective for manufacturing of a long product.

In the impact absorbing body 2 in which no load reducing holes 3 are disposed, the load on the central portion in the right and left direction is larger than on the both end portions in the right and left direction. Thus, distribution of the load of the impact absorbing body 2 is not uniform throughout entire length in the right and left direction.

In the impact absorbing member 1 of this embodiment, the load reducing holes 3 are disposed in a section including the central portion in the right and left direction of the impact absorbing body 2. Thus, the load on the central portion in the right and left direction can be decreased. Therefore, a difference between the load on the central portion in the right and left direction and the load on both end portions in the right and left direction can be decreased. That is, unevenness in distribution of the load of the impact absorbing body 2 can be suppressed. Further, the distribution of the load of the impact absorbing body 2 can be adjusted by a simple work of boring.

In the impact absorbing member 1 of this embodiment, no load reducing holes 3 are disposed in the inner ribs 21. Consequently, when the inner rib 21 is deformed by tension, the inner rib 21 can be prevented from being broken with the edge of the load reducing hole 3 acting as a starting point.

In the impact absorbing member 1 of this embodiment, the load reducing holes 3 are bored in the input wall portion 200 and the output wall portion 201. The input wall portion 200 and the output wall portion 201 are developed substantially perpendicular (up/down and right/left direction) to the direction of load input (back and forth direction). Thus, the load on the central portion in the right and left direction of the impact absorbing body 2 can be reduced effectively.

In the impact absorbing member 1 of this embodiment, the diameter of the load reducing hole 3 is set to more than 0% to 90% or less when the entire length in the up/down direction of the impact absorbing body 2 is assumed to be 100%. Thus, the adjustment of the load on the central portion in the right and left direction of the impact absorbing body 2 is simple.

In the impact absorbing member 1 of this embodiment, the interval between most adjacent portions of the pair of the load reducing holes 3 adjacent in the right and left direction is set to more than 0 mm to 80 mm or less. In this respect also, the adjustment of the load on the central portion in the right and left direction of the impact absorbing body 2 is simple.

According to the manufacturing method of the impact absorbing member 1 of this embodiment, the load on the central portion in the length direction (right and left direction) of the impact absorbing body 2 can be decreased simply. Further, according to the manufacturing method of the impact absorbing member 1 of this embodiment, at first the sectional shape in the direction of a short side (up/down and front/rear direction) of the impact absorbing body 2 is set corresponding to the both end portions in the length direction which requires the strength most. Next, the load reducing holes 3 are bored in the central portion in the length direction of the impact absorbing body 2. Thus, the distribution of load throughout the entire length in the length direction of the impact absorbing body 2 can be set up freely.

### Second Embodiment

The impact absorbing member and manufacturing method of this embodiment are different from the impact absorbing member and manufacturing method of the first embodiment in that the impact absorbing member is disposed on the roof side rail portion, not on the bumper beam. Therefore, only this different point will be described here.

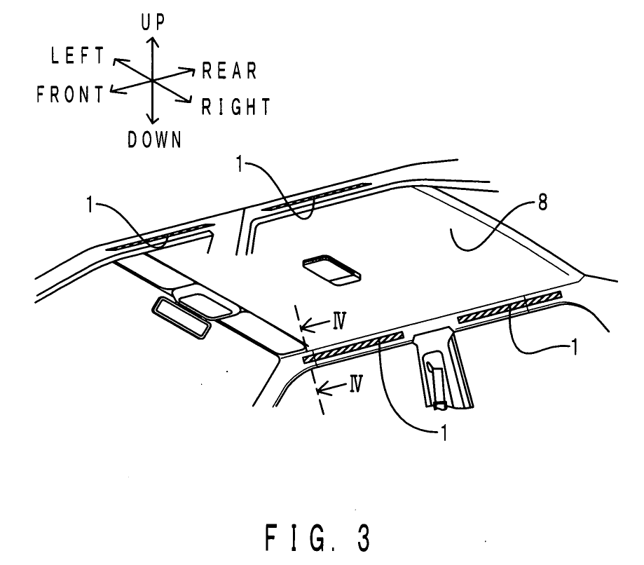

FIG. 3 shows a perspective view of the interior of a vehicle compartment in which the impact absorbing member is disposed of this embodiment. Note that components corresponding to those in FIG. 1 are denoted by the same reference symbols. As shown in FIG. 3, a roof lining 8 made of resin is disposed on the vehicle roof. Two columns in the back and forth direction of the impact absorbing members 1 (expressed by hatching in FIG. 3) are accommodated on each of right and left edges of the interior of the roof lining 8. That is, totally four columns of impact absorbing members 1 are disposed on the roof lining 8.

Hereinafter, the arrangement and structure of the impact absorbing member 1 located on the front right inside the roof lining 8 will be described. The arrangement and structure of the impact absorbing members 1 of remaining three columns are the same as the impact absorbing member 1 disposed on the front right. Therefore, description thereof is omitted.

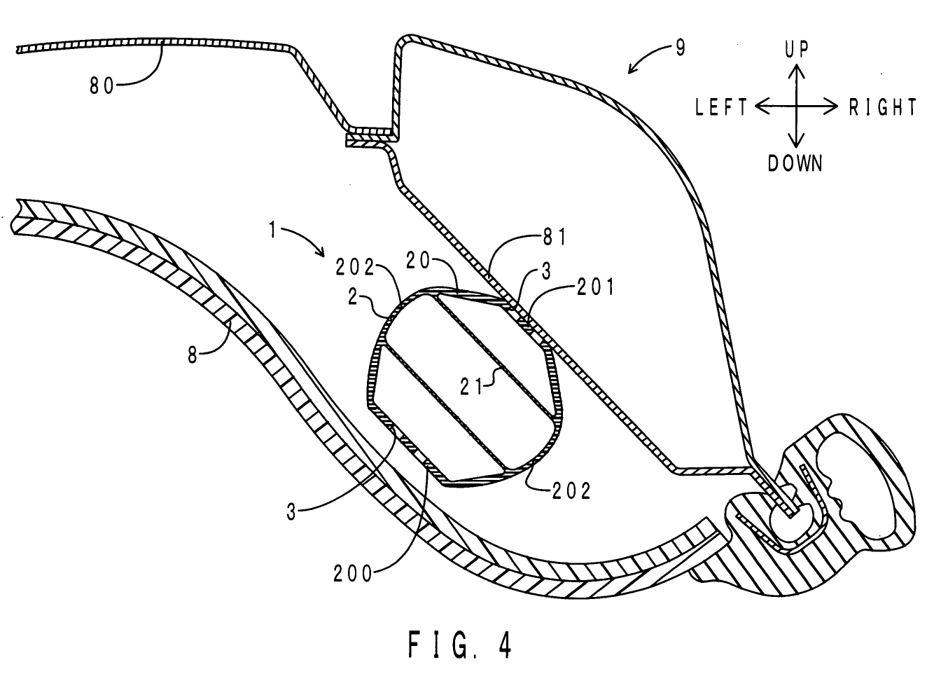

FIG. 4 shows a sectional view taken along line IV-IV in FIG. 3. Note that components corresponding to those in FIG. 2 are denoted by the same reference symbols. As shown in FIG. 4, a loop panel 80 made of steel is disposed apart at a predetermined distance above the roof lining 8. The loop panel 80 forms the contour of the vehicle 9. A high stiffness roof side rail portion 81 made of steel is interposed between the roof lining 8 and the roof panel 80. The roof side rail portion 81 is included in the adjacent member of the present invention. The impact absorbing member 1 is fixed to the bottom face of the roof side rail portion 81 with adhesive agent.

The impact absorbing member 1 and manufacturing method of this embodiment have the same operation and effect about portion having a common structure as the impact absorbing member and the manufacturing method of the first embodiment. The impact absorbing member 1 of this embodiment can absorb an impact applied to the head of a passenger when a collision occurs.

### OTHER EXAMPLES

Embodiments of the impact absorbing member and manufacturing method according to the present invention were described above. However, the embodiments are not necessarily limited to those described above, and the present invention may be implemented in various modified and improved aspects evident to a person skilled in the art.

For example, the configuration of the impact absorbing body 2 is not limited particularly. It may be of polygon, such as triangle, rectangle, pentagon, hexagon. Further, it may be of perfect circle, ellipse or semi-circle. The material of the impact absorbing body 2 is also not limited particularly. It is permissible to use polyamide (PA), polycarbonate (PC), alloy of PC and polybutylene terephthalate (PBT), alloy of PC and polyethylene terephthalate (PET), polypropylene (PP), polyethylene (PE), acrylonitrile butadiene styrene (ABS) or the like. In addition, the forming method of the impact absorbing body 2 is not limited particularly. It is permissible to use injection molding, blow molding and the like.

The shape of the load reducing hole 3 is not limited particularly. It may be of ellipse or semi-circle. Further, it may be formed into a polygonal shape, such as triangular, rectangular, pentagon or hexagon. The size and number of arrangement of the load reducing holes are not limited. The arrangement method of the load reducing holes 3 is not limited. In addition to by boring, the load reducing holes may be disposed at the same time when the impact absorbing body 2 is formed.

The arrangement place of the impact absorbing member 1 is not limited particularly. From viewpoints of protecting passengers, it may be disposed on the back of a member exposed in the vehicle compartment. For example, it may be disposed on the back of a front pillar, center pillar, front door trim, rear door trim and instrument panel. Further, from viewpoints of protecting a pedestrian, the impact absorbing member 1 may be disposed on the back of a member which the pedestrian likely collides with. For example, it may be disposed on the back of a rear bumper, side molding or the like. The impact absorbing member may be disposed on the front side of these exposed members as well as on the back thereof.

### PRACTICAL EXAMPLES

Hereinafter, a striker crash experiment performed about the impact absorbing member of the present invention will be described.

### <Sample>

### PRACTICAL EXAMPLE SAMPLE

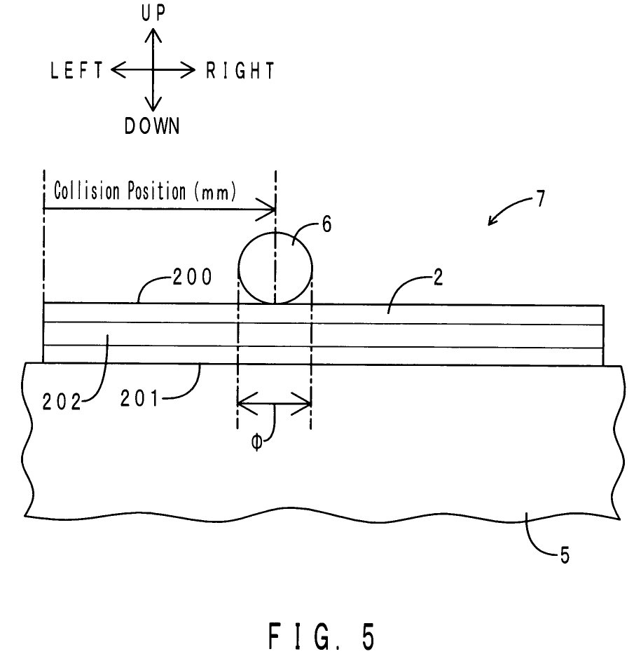

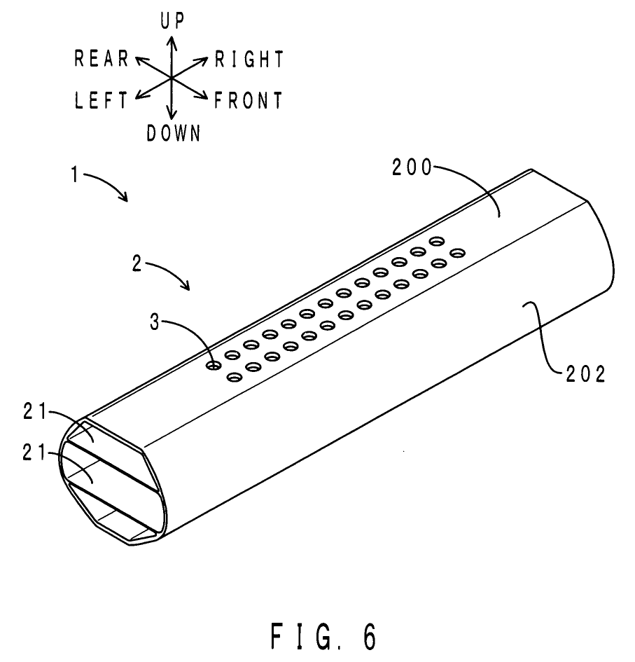

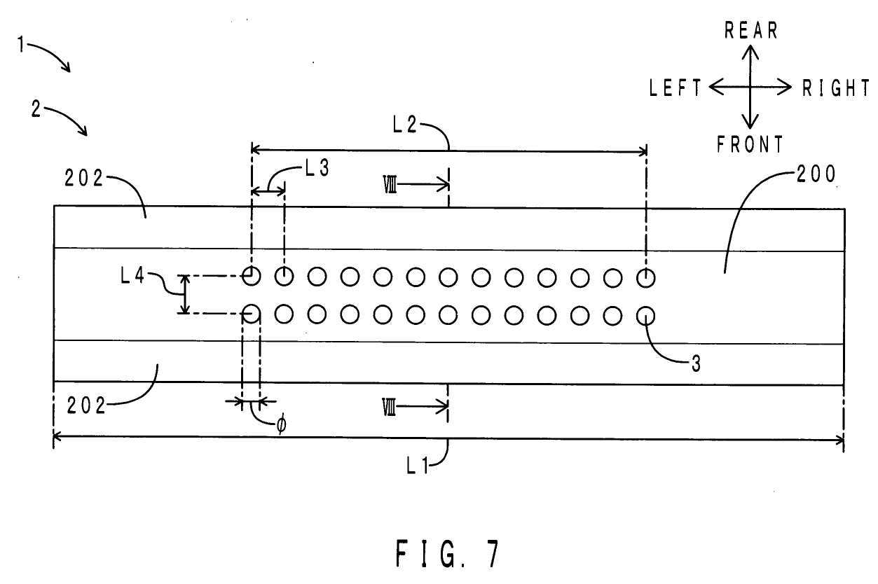

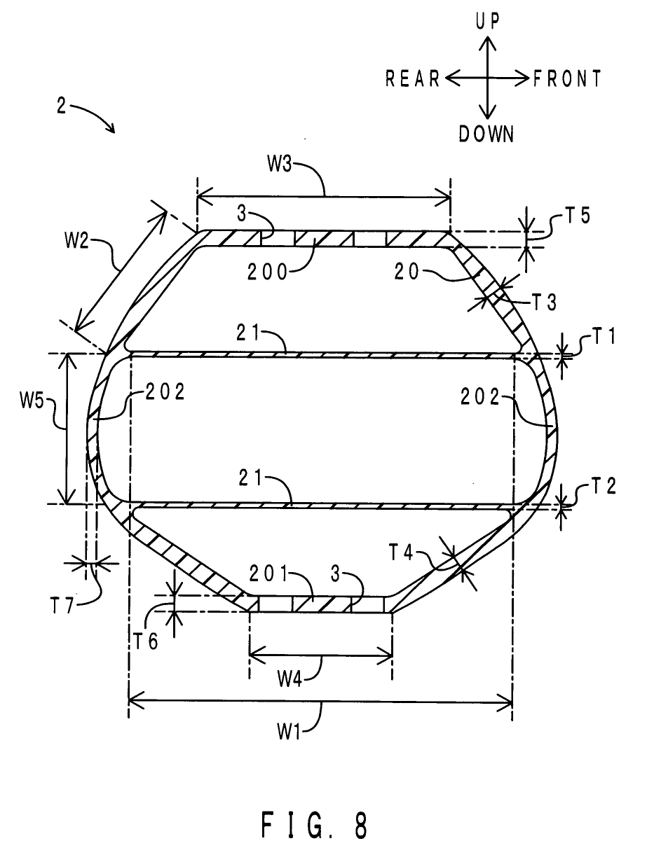

First, the practical example sample will be described. FIG. 5 shows a schematic diagram of striker crash experiment. FIG. 6 shows a perspective view of the practical example sample. FIG. 7 shows a top view of the practical example sample. FIG. 8 shows a sectional view taken along line VIII-VIII in FIG. 7. Note that components corresponding to those in FIG. 2 are denoted by the same reference symbols. As shown in FIG. 5-FIG. 8, the practical example sample 7 and the impact absorbing member of the first embodiment are substantially equal except the size, the number of disposed holes and the size of arrangement section of the load reducing hole 3.

As shown in FIG. 7, the entire length L1 in the right and left direction of the practical example sample 7 is 600 mm. Further, an interval between the center of the load reducing hole 3 disposed to the leftmost and the center of the load reducing hole 3 disposed to the rightmost of the input wall portion 200, that is, the entire length L2 of the hole arrangement section is 300 mm. In the input wall portion 200, the center in the right and left direction of the hole arrangement section and the center in the right and left direction of the impact absorbing body 2 are coincident with each other. Further, in the input wall portion 200, an interval between the centers of a pair of the load reducing holes 3 that are adjacent in the right and left direction, that is, a right and left direction pitch L3 of the load reducing hole 3, is 25 mm. In the input wall portion 200, the interval between the centers of the load reducing hole 3 on two rows adjacent in the back and forth direction, that is, between-row distance L4 of the load reducing hole 3, is 28 mm. Further, the diameter φ of the load reducing hole 3 in the input wall portion 200 is 13.5 mm. An interval between a pair of the edges (portions nearest each other) the load reducing hole 3 adjacent in the right and left direction is 11.5 mm(=L3−2×φ/2).

In the meantime, the arrangement, size and the like of the load reducing hole 3 in the output wall portion 201 are equal to the arrangement, size and the like of the input wall portion 200. That is, the load reducing hole 3 in the input wall portion 200 and the load reducing hole 3 in the output wall portion 201 oppose each other in the vertical direction. Thus, description thereof is omitted here.

As shown in FIG. 8, the length W1 in the back and forth direction of a pair of the inner ribs 21 is 109 mm. The length W2 of an interval between the input wall portion 200 and the upper inner rib 21 on the connecting wall portion 202 is 40 mm. The length W3 in the back and forth direction of the input wall portion 200 is 60 mm. The length W4 in the back and forth direction of the output wall portion 201 is 40 mm. The length W5 of an interval between the pair of the upper and lower inner ribs 21 in the connecting wall portion 202 is 40 mm.

The thickness T1 of the upper inner rib 21 is 0.5 mm. The thickness T2 of the lower inner rib 21 is 0.7 mm. Further, the thickness T3 of an interval between the input wall portion 200 and the upper inner rib 21 on the connecting wall portion 202 is 3 mm. The thickness T4 of an interval between the output wall portion 201 and the lower inner rib 21 on the connecting wall portion 202 is 3.5 mm. The thickness T5 of the input wall portion 200 is 3.5 mm. The thickness T6 of the output wall portion 201 is 4 mm. Further, the thickness T7 of an interval between a pair of the upper and lower inner ribs 21 on the connecting wall portion 202 is 3 mm.

### COMPARATIVE EXAMPLE SAMPLE

Next, the comparative example sample will be described. The comparative example sample is the practical example sample 7 excluding the load reducing holes. That is, only the impact absorbing body 2 of the practical example sample 7 was used as the comparative sample.

### <Experimental Method>

As shown in FIG. 5, the striker 6 is a rigid body, which is a cylinder of 100 mm in diameter and 1 m in length. The mass of the striker 6 is 26.5 kg. The practical example sample 7 and the comparative example sample were hit against the striker 6 such that the length direction of the striker 6 and the length direction of the practical example sample 7 and the comparative example sample were perpendicular to each other. The crash speed of the striker 6 was set to 16 km/h.

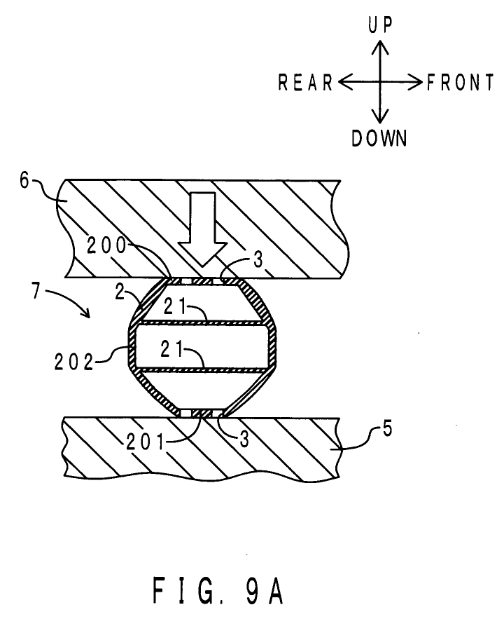

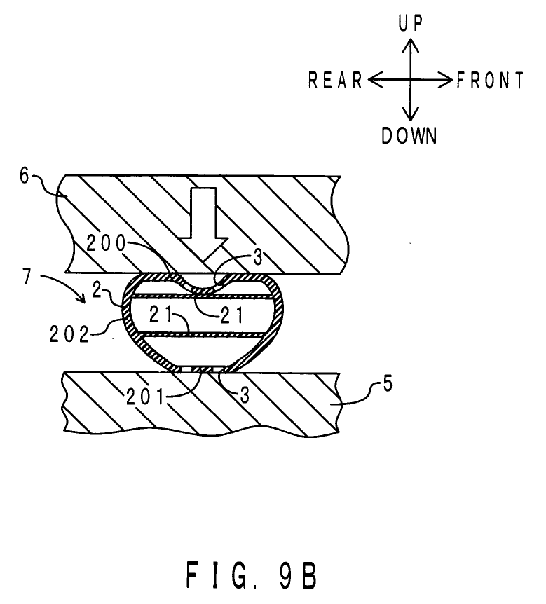

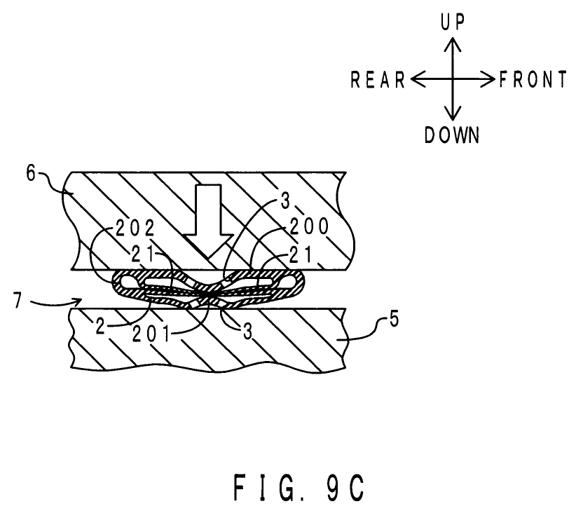

FIG. 9A shows a condition of collision initial period when the central portion in the right and left direction of the practical example sample 7 was hit against a striker 6. FIG. 9B shows a condition of collision intermediate period when the central portion in the right and left direction of the practical example sample was hit against a striker 6. FIG. 9C shows a condition of collision termination period when the central portion in the right and left direction of the practical example sample 7 was hit against a striker 6. As shown in FIG. 9A-FIG. 9C, the practical example sample 7 was crushed between the striker 6 located up and the table 5 located down. The inner ribs 21 of the impact absorbing body 2 were deformed by tension in the back and forth direction by a load at the time of collision.

The sections including the central portion in the right and left direction of the input wall portion 200 and the output wall portion 201 of the impact absorbing body 2 are provided with the load reducing holes 3. Thus, the input wall portion 200 is sunk downward relatively easily and deformed. The pair of the connecting wall portions 202 are expanded in the back and forth direction relatively easily.

### <Result of Experiment>

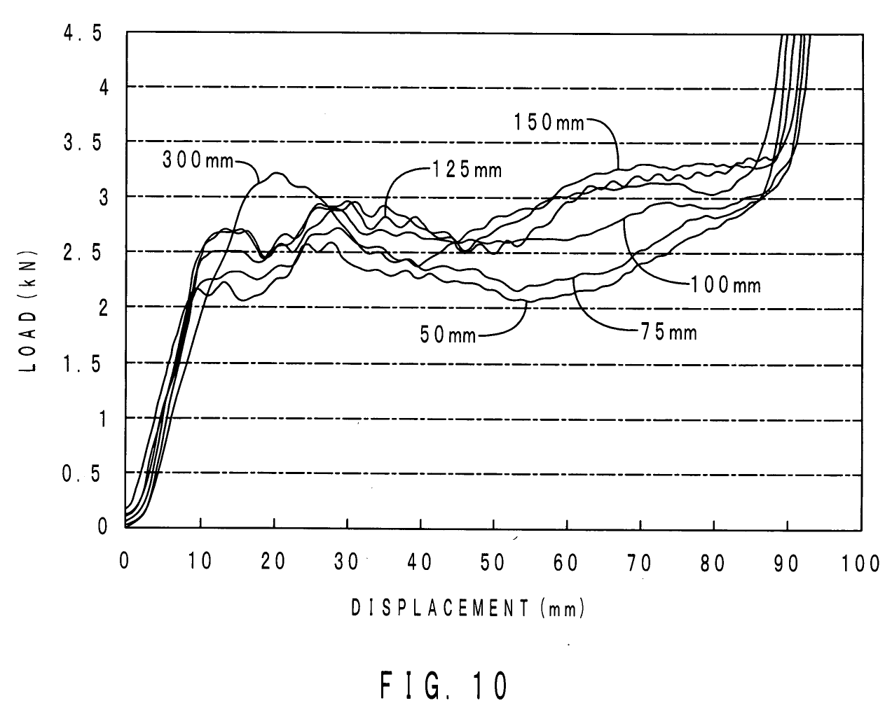

FIG. 10 shows the relation between displacement and load at a predetermined collision position (see FIG. 5) of the practical example sample 7. The displacement mentioned here refers to a displacement in the downward direction of a collision position when the striker 6 collides. The load mentioned here refers to a load applied to the collision position (reaction force which the striker 6 receives from the collision position) when the striker 6 collides.

As shown in FIG. 10, it is evident that the load with respect to the displacement is changed little regardless of the collision position. That is, it is evident that the load on a hole arrangement section L2 (see FIG. 7) from 300 mm of the collision position (center in the right and left direction) to 150 mm of the collision position is not largely different from loads on 125 mm of the collision position, 100 mm of the collision position, 75 mm of the collision position, and 50 mm of the collision position.

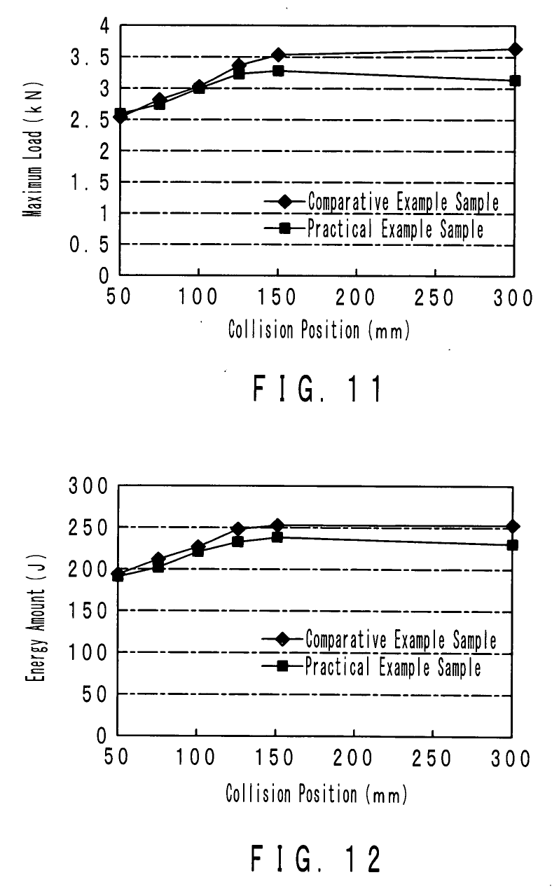

FIG. 11 shows the relation between the collision position and maximum load of the practical example sample 7 and the comparative sample. As shown in FIG. 11, it is evident that the practical example sample 7 has a smaller maximum load than the comparative example sample. Further, it is evident that dispersion of the maximum load depending on the collision position is small.

FIG. 12 shows the relation between the collision position and energy amount of the practical example sample 7 and the comparative example sample. As shown in FIG. 12, it is evident that the practical example sample 7 has a smaller absorbed energy amount than the comparative example sample. Further, it is evident that dispersion of the energy amount depending on the collision position is small. FIGS. 11, 12 indicate that the practical example sample 7 can secure a more uniform impact absorbing performance than the comparative example sample when the striker 6 collides with any position of the impact absorbing body 2.

What is claimed is:

1. An impact absorbing member comprising:
a long impact absorbing body in which the sectional shape in the direction of a short side thereof is substantially identical throughout the entire length in the length direction; and
at least one load reducing hole disposed at load reducing object portion of the impact absorbing body.

2. The impact absorbing member according to claim 1, wherein the load reducing object portion is a central portion in the length direction of the impact absorbing body.

3. The impact absorbing member according to claim 1, wherein the impact absorbing body includes an outer cylinder and a plurality of inner ribs whose faces are developed substantially perpendicular to the direction of a load input at the time of a collision while connecting the inner faces of the outer cylinder and deformed by tension at the time of a collision, wherein the load reducing hole is bored in the outer cylinder.

4. The impact absorbing member according to claim 3, wherein the outer cylinder includes an input wall portion to which a load is input, an output wall portion which outputs the load to an adjacent member while disposed substantially in parallel to the input wall portion; and a pair of connecting wall portions for connecting the input wall portion with the output wall portion, wherein a pair of the inner ribs are disposed substantially in parallel to the input wall portion and the output wall portion while the pair of the inner ribs connect the inner faces of the pair of the connecting wall portions, and the load reducing holes are bored in the input wall portion and the output wall portion.

5. The impact absorbing member according to claim 1, wherein the diameter of the load reducing hole is set to more than 0% to 90% or less when the entire length in the direction of a short side of the impact absorbing body is assumed to be 100%.

6. The impact absorbing member according to claim 1, wherein a plurality of the load reducing holes are disposed and an interval between most proximate positions of a pair of the load reducing holes adjacent each other in the length direction of the impact absorbing body is set to more than 0 mm to 80 mm or less.

7. A manufacturing method of impact absorbing member comprising:
extrusion molding step of forming an impact absorbing body having a sectional shape in the direction of a short side corresponding to a portion requiring a strength most by extrusion molding; and hole arranging step of arranging at least one load reducing hole at a load reducing object portion of the impact absorbing body.
